(19) United States
(12) Patent Application Publication
(10) Pub. No.: US 2014/0265341 A1
(43) Pub. Date: Sep. 18, 2014

(54) Apparatus and method for generating electricity using gravity acceleration and buoyancy

(71) Applicants: Gyu Eob Hwang, Fairfax, VA (US); Si Dae Kim, Daegu (KR)

(72) Inventors: Gyu Eob Hwang, Fairfax, VA (US); Si Dae Kim, Daegu (KR)

(21) Appl. No.: 13/844,835

(22) Filed: Mar. 16, 2013

(51) Int. Cl. F03B 13/16

(52) U.S. Cl. CPC F03B 13/16
USPC 290/53

(57) ABSTRACT

Gravitational potential energy of a weight raised to a height is converted into kinetic energy and then into electricity, as the weight falls from the height. An apparatus includes a buoyant weight, a gravity fall chamber including a chain, a buoyancy chamber including a liquid, and a receiving portion connecting the gravity fall chamber and buoyancy chamber. The buoyant weight is raised to the height near a top of the gravity fall chamber and then allowed to fall from the height. The fall of the weight moves the chain which in turn operates a generator for producing electricity from the potential energy. After falling from the height, the weight is submerged in the liquid in the receiving portion and rises to a surface level of the liquid inside the buoyancy chamber before being positioned in a predetermined position for another fall in the gravity fall chamber.

### TECHNICAL FIELD

This disclosure relates to methods and apparatuses for generating electricity using repeated application of natural laws and resources, such as gravity acceleration and buoyancy of an object.

### BACKGROUND

Electricity is a necessity in modern society. Most people cannot imagine living a day without electricity because people are so used to enjoying benefits of modern technologies, such as computers, video games, smart TVs, radios, lights, etc. that require electricity. Nowadays, being without electricity for a couple of days or weeks can be a disaster to many people. Often times, power outages are characterized as disasters resulting in a great financial loss to on-going business concerns and individual homes.

Traditionally, electricity has been produced by natural and/or man-made resources such as coal, water, atomic energy, etc. Many different technologies are available for generating electricity for public use, but they often require large investments and costs in building generation facilities and infrastructures. More often than not, the conventional technologies for generating electricity suffer from low efficiencies and losses when generated electricity is delivered to industrial facilities and individual homes for use.

Also, various alternative technologies based on naturally abundant resources, such as solar power, wind power, sea water, etc. have been proposed and considered, but they have not resulted in widely accepted commercial success because of high investment costs and low efficiency reasons in connection with generating and delivering electricity to end users. For example, in recent years, solar, wind, sea water based electricity generation plants have been proposed and built in various locations throughout the countries. However, they suffer many disadvantages. For instance, a solar or wind power based facility does not generate and provide enough electricity, as needed by individual homes and industrial plants, because of often unpredictable environmental factors, such as weather and climate conditions. These natural resources based electricity generation facilities cost millions of dollars, even if not billions of dollars, at the beginning of set up and maintenance of the facilities, and often do not deliver purported benefits to customers.

The conventional electricity generation technologies tend to be highly inefficient in production and delivery of electricity to end users, i.e., losing a great deal of electricity generated before the generated electricity is used by end consumers (e.g., individual home users and industrial users alike) that are remotely located from the location of electricity generation plants. Thus, there is a need for more cost effective and energy efficient techniques for generating and delivering electricity to individual homes and industrial facilities alike.

### BRIEF DESCRIPTION OF THE DRAWINGS

The drawing figures depict one or more implementations in accord with the present teachings, by way of example only, not by way of limitation. In the figures, like reference numerals refer to the same or similar elements.

FIG. 1 illustrates a high level diagram of an exemplary apparatus for generating electricity in accordance with disclosed subject matter.

FIG. 2A is an inside view of the chamber unit of the exemplary apparatus.

FIG. 2B illustrates a high level operational flow chart for an exemplary embodiment.

FIG. 3A illustrates a top portion of the exemplary apparatus.

FIGS. 3A and 3B illustrate a top portion of the exemplary chamber unit.

FIG. 3C illustrates a side view of a receiving portion of the chamber unit coupled to the generator unit.

FIG. 3D illustrates an exemplary motor-screw drive system.

FIGS. 4A and 4B illustrate exemplary embodiments including one or more chains with one or more support members.

FIG. 5 shows a perspective view of an exemplary generator unit.

FIG. 6 illustrates a cross-cut view of an exemplary weight.

FIGS. 7A and 7B provide functional block diagram illustrations of a controller unit.

It should be understood that the drawings are not necessarily to scale. In certain instances, details that are not necessary to the understanding of disclosed subject matter or render other details difficult to perceive may have been omitted. It should be understood, of course, that the disclosed subject matter is not necessarily limited to the particular embodiments illustrated herein.

### DETAILED DESCRIPTION

In the following detailed description, numerous specific details are set forth by way of examples in order to provide a thorough understanding of the relevant teachings. However, it should be apparent that the present teachings may be practiced without such details. In other instances, well known methods, procedures, components, and/or circuitry have been described at a relatively high-level, without detail, in order to avoid unnecessarily obscuring aspects of the present teachings.

In physics, potential energy is the energy of an object due to a position of the object (i.e., raised to a height from a ground level). Potential energy is often associated with restoring forces, such as the force of gravity. Gravity is generally described as force pulling all matters. Gravity exerts a constant downward force on the center of mass of an object moving near the surface of the earth. The action of lifting an object having mass from an initial position is performed by an external force that works against a force field of the potential. Also, work is stored in the force field, which is often said to be stored as potential energy. If the external force is removed, the force field acts on the object to perform the work as it moves the object back to the initial position (i.e., a ground level), causing the object to fall. The potential energy due to an elevated position is called gravitational potential energy.

According to laws of physics, an amount of potential energy required to raise an object having mass to a height from the surface of the earth is equal to the product of the mass of the object times the acceleration due to gravity times the height. That is, an amount of the potential energy at an elevated position is directly proportional to the height of the elevated position. Further, when an object is submerged in a liquid, it rises to a surface of the liquid if a weight of the object is less than a weight of a volume of the liquid displaced by the object, that is, when the object is buoyant.

The present disclosure utilizes these natural laws and principles, such as gravity or gravity acceleration and buoyancy. That is, one or more buoyant weights can be raised to a certain height, building and storing up a significant amount of gravitational potential energy of the one or more weights in the raised position. When the one or more weights raised to the certain height are allowed to fall, the one or more weights translate the stored gravitational potential energy into kinetic energy as the one or more weights reach the ground. A significant advantage of the present disclosure is repeated use of raising the one or more weights to a height using buoyancy and allowing to fall and accelerate due to gravity, thereby converting the stored gravitational potential energy into the kinetic energy, which in turn converted into electricity.

The examples discussed herein provide methods and apparatuses for producing electricity by converting gravitational potential energy into kinetic energy using natural laws or phenomena, such as gravity, gravity acceleration and buoyancy of an object.

In one embodiment, an apparatus for generating electricity includes a weight, a gravity fall chamber, means for receiving the weight as the weight falls from a top of the gravity fall chamber, a buoyancy chamber, and a receiving portion. The gravity fall chamber includes a fall gate disposed at a bottom portion of the gravity fall chamber. The means for receiving the weight is configured to receive the weight as the weight falls from a height near a top of the gravity fall chamber and makes downward movement together with the received weight in the gravity fall chamber. As the weight falls from the height, it accelerates due to gravity of the earth exerted upon the weight. The buoyancy chamber includes a liquid inside the buoyancy chamber and a buoyancy gate disposed at a bottom portion of the buoyancy chamber. The receiving portion is configured to connect the gravity fall chamber and the buoyancy chamber, so as to create a passage for the weight to move from the gravity fall chamber into the buoyancy chamber. The fall gate of the gravity fall chamber is configured to open when the weight falls and exits the gravity fall chamber into the receiving portion, while the buoyancy gate is closed. The buoyancy gate of the buoyancy chamber is configured to open such that the weight can move into the buoyancy chamber from the receiving portion, while the fall gate of the gravity fall chamber is closed. The weight is configured to weigh less than a weight of a value of the liquid displaced by the weight when the weight is submerged within the liquid.

In another embodiment, a method for generating electricity using an apparatus based on gravity, gravity acceleration and buoyancy is provided. The apparatus includes one or more weights, a gravity fall chamber, a buoyancy chamber filled with a liquid, and a receiving portion, wherein the gravity fall chamber includes a fall gate and a chain including a support member, and the buoyancy chamber includes a buoyancy gate. The one or more weights are allowed to fall from a height in the gravity fall chamber. The one or more weights are received via the support member of the chain. A combined mass of the one or more weights and the support member causes to move the chain downward, as the combined mass of the one or more weights falls in the gravity fall chamber. The fall gate is operated to open such that the one or more weights move from the gravity fall chamber into the receiving portion, while the buoyancy gate is operated to remain closed. The receiving portion is configured to connect the gravity fall chamber and the buoyancy chamber so as to allow the one or more weights to move from the gravity fall chamber into the buoyancy chamber. The one or more weights are projected toward into the buoyancy chamber. The buoyancy gate is operated to open so that the one or more weights move from the receiving portion into the buoyancy chamber and subsequently rise in the liquid to a surface level of the liquid within the buoyancy chamber, while the fall gate remains closed. Each of the one or more weights is configured to weigh less than a weight of a volume of the liquid disposed by the weight when the weight is submerged within the liquid.

In another embodiment, an apparatus for generating electricity using gravity, gravity acceleration and buoyancy, includes a gravity fall chamber including a fall gate disposed at or near a bottom of the gravity fall chamber, a buoyancy chamber including a liquid and a buoyancy gate disposed at or near a bottom of the buoyancy chamber, a chain including a plurality of support members, and a receiving portion configured to connect the gravity fall chamber and the buoyancy chamber so as to create a passage for the one or more weights to move from the gravity fall chamber into the buoyancy chamber. The buoyancy chamber is disposed substantially vertically adjacent the gravity fall chamber. The chain is disposed inside the gravity fall chamber substantially along a longitudinal side of the gravity fall chamber. The plurality of support members is configured to receive one or more weights as the one or more weights fall and accelerate from a height in a predetermined position near a top of the gravity fall chamber and move the chain downward. Each of the one or more weights is configured to weigh less than a weight of a volume of the liquid displaced by the weight when the weight is submerged within the liquid. The fall gate of the gravity fall chamber is configured to open such that each weight moves from the gravity fall chamber into the receiving portion while the buoyancy gate of the buoyancy chamber is closed, and the buoyancy gate of the buoyancy chamber is configured to open such that the weight moves from the receiving portion into the buoyancy chamber for rise to a surface level of the liquid due to buoyancy inside the buoyancy chamber.

As a result, the disclosed techniques and apparatuses herein can lead to generation of electricity, using naturally abundant resources, such as gravity, gravity acceleration and buoyancy, without having complicated and costly equipment.

Reference now is made in detail to the examples illustrated in the accompanying drawings and discussed below.

FIG. 1 illustrates a high level diagram of an exemplary apparatus 10 for generating electricity in accordance with disclosed subject matter herein. The exemplary apparatus 10 comprises a chamber unit 12, a generator unit 13, and a control box 11. The chamber unit 12 encloses a gravity fall chamber and a buoyancy chamber (not shown in FIG. 1), which are described below in detail. Also, FIG. 1 shows an inside view 14 of the generator unit 13, disclosing components such as a flywheel and a generator motor. The control box 11 encloses a controller unit comprising one or more processors (not shown in FIG. 1).

FIG. 2A is an inside view of the chamber unit 12 of the exemplary apparatus 10. In one embodiment, the chamber unit 12 includes a gravity fall chamber 201, a buoyancy chamber 203, a top portion 205, and a receiving portion 207. In the embodiment shown in FIG. 2A, the chamber unit 12 is separated into the gravity fall chamber 201 and the buoyancy chamber 203 by a partition 209. That is, the gravity fall chamber 201 is disposed adjacent the buoyancy chamber 203. Alternatively, the gravity fall chamber 201 and buoyancy chamber 203 may be separated at a distance from each other (i.e., two separate chambers disposed at a short distance from each other). The gravity fall chamber 201 includes one or more substantially vertically disposed fall guides 211 inside the gravity fall chamber 201. The one or more fall guides 211 provide one or more weights 213 with a predefined fall passage 215 due to gravity inside the gravity fall chamber 201. At or near a bottom portion of the gravity fall chamber 201, the gravity fall chamber 201 includes a fall gate 217 (as shown in FIG. 3C). The gravity fall chamber 201 further includes a chain 219 and one or more support members 221 coupled to the chain 219. The gravity fall chamber 201 includes a liquid 223, such as water, etc., to a certain level (i.e., as indicated by a dotted line) in the bottom portion of the gravity fall chamber 201. Also, FIG. 2A shows a fall chamber liquid level controller 222 and a buoyancy chamber liquid level controller 249. The fall chamber liquid level controller 222 is disposed near the bottom of the gravity fall chamber 201 for draining the liquid 223 (or allowing the liquid 223 to flow out of the gravity fall chamber 201) so as to maintain a predefined surface level (i.e., as indicated by a dotted line) of the liquid 223 in the bottom portion of the gravity fall chamber 201. The buoyancy chamber liquid level controller 249 is disposed on the buoyancy chamber 203 so as to maintain a predefined surface level (i.e., as indicated by a dotted line) of the liquid 223 in the buoyancy chamber 203.

FIG. 2B illustrates a high level operational flow chart for operation of the exemplary embodiment. In the exemplary embodiment discussed herein, the fall gate 217 of the gravity fall chamber 201 is configured to open or close the bottom portion of the gravity fall chamber 201. For example, at S1, as shown in FIG. 2A, as the weight 213 (or 213′, 213″, 213′″, 213″″) is allowed to fall from a height in a predetermined position near a top of the gravity fall chamber 201, at S2, the weight 213 is received by a support member 221 of the chain 219. At S3, a combined mass of the weight 213 and support member 221 is allowed to fall, thereby making downward movement of the chain 219, as the combined mass falls and accelerates towards a bottom of the gravity fall chamber 201. At S4, the fall gate 217 is operated to open such that the weight 213 continues to fall into the receiving portion 207 while operating the buoyancy gate 253 to remain closed. The opening of the fall gate 217 provides an obstructed passage for the weight 213 from the gravity fall chamber 201 into the receiving portion 207. At S5, the weight 213 is received into the receiving portion 207. At S6, the fall gate 217 is operated to close after the weight 213 passes from the gravity fall chamber 201 into the receiving portion 207. At S7, the received weight 213 is moved from the receiving portion 207 into the buoyancy chamber 203. At S8, the buoyancy gate 253 is operated to open so as for the weight 213 to move from the receiving portion 207 into the buoyancy chamber 203 and rise to a surface level of the liquid 223 contained in the buoyancy chamber 203, while operating the fall gate 217 to remain closed.

FIG. 3A shows a top portion 205 of the exemplary chamber unit 12 in more detail. In FIG. 3A, the weight stopper 265 is shown to have engaged with the weight W1 before the weight W1 is allowed to fall into the gravity fall chamber 201. The weight W1 is disposed in a predetermined position near a top of the gravity fall chamber 201. In the example, the weight stopper 265 includes an elongated curved body 267 comprising a finger-like lower portion X and upper portion Y, a motor 261, and a link 269, where the link 269 operationally couples the motor 261 and weight stopper 265. The motor 261 receives a control signal from the controller unit regarding whether to release the weight W1 at a certain release time from the predetermined position. The release time can be set as a predetermined time by the controller unit. Alternatively, the release time can be stored in memory of the controller unit. In the example, the release time can be determined in real time based on various information, such as information on the positions of one or more weights 213.

As noted, the controller unit operates the weight stopper 265 by sending a control signal to the motor 261 to release the weight 213 (W1) into the gravity fall chamber 201. Upon receipt of the control signal, the motor 261 turns the link 269 and thus operates or moves the weight stopper 265 as follows. As the link 269 moves in one direction, the lower portion X of the weight stopper 265 moves in an upward direction N, thereby releasing the weight W1 into the gravity fall chamber 201 for a fall. At the same time, the upper portion Y of the weight stopper 265 moves in a downward direction D to prevent the weight W2 from moving into the predetermined position for a fall (or a drop position) into the gravity chamber 201. After the weight W1 is released from the drop position, the motor 261 moves the link in a reverse direction, engaging the weight stopper 265 to lift up the upper portion Y (i.e., move the lower portion X in the direction S) such that the weight W2 moves along a semi-circular top guide 263 into the predetermined drop position above the top portion of the gravity fall chamber 201.

As noted, the weight stopper 265 is configured to hold the weight 213 as the weight 213 moves from the buoyancy chamber 203 into the predetermined position before a fall into the gravity fall chamber 201. In the example shown in FIG. 3A, the weight stopper 265 includes a body member 267, a motor 261 and a link 269 coupling the body member 267 and the motor 261. The body member 267 includes two finger ends X and Y and is configured to hold the weight 213 in a predetermined position as the weight 213 leaves the buoyancy chamber 203 and moves towards the gravity fall chamber, before being released for a fall into the gravity fall chamber 201. In the example, the weight stopper 265 is controlled by the controller unit of the control box 14. Alternatively, instead of the control box 14, the weight stopper 265 can be controlled by other computing devices (e.g., a co-located or separate computer or micro-processor) to ensure proper timings of the release of the one or more weights 213. Alternatively, the weight W1 can be held in the predetermined position using a non-mechanical means, such as high-pressurized air or gas jets, etc. or the like.

In the example shown in FIG. 3A, the semi-circular top guide 263 is disposed in an arc fashion over top portions of the gravity fall chamber 201 and buoyancy chamber 203. The semi-circular top guide 263 is designed to facilitate smoother movement of the weight W2 from the buoyancy chamber 203 into the predetermined position for a fall into the gravity fall chamber 201. As the multiple weights (e.g., W1, W2, W3, etc.) rise to a top surface level of the liquid 223 contained inside the buoyancy chamber 203, the weights can be stacked on top of each other. Further, the buoyancy chamber 203 is equipped with a buoyancy chamber liquid level controller 249 disposed near the top portion of the buoyancy chamber 203 to maintain a predetermined level of liquid 223 in the buoyancy chamber 203. Maintaining the predetermined level of liquid 223 helps the weight 213 to easily move from the buoyancy chamber 203 into the predetermined drop position over the top portion of the gravity fall chamber 201 without much hindrance. The buoyancy chamber liquid level controller 249 can be operated manually or automatically by the controller unit. It is noted that the buoyancy chamber liquid level controller 249 is not necessary for the operation of the exemplary embodiment discussed herein, and thus alternatively, another exemplary embodiment may not include the buoyancy chamber liquid level controller 249.

FIG. 3B illustrates a horizontal cut view of the top portion (along a line A-A in FIG. 3A) of the chamber unit 12. FIG. 3B shows the chains 219 and support member 221 attached to the chains 219. As can be seen in FIG. 3B, three fall guides 211 are vertically disposed in the gravity fall chamber 201 such that the weight 213 falls along a passage defined by the three fall guides 211 in the gravity fall chamber 201. Also, three buoyancy guides 245 are disposed in the buoyancy chamber 203 such that the weight 213 rises along a passage defined by the three buoyancy guides 245.

FIG. 3C illustrates a side view of a receiving portion 207 of the chamber unit 12 coupled to the generator unit 13. The receiving portion 207 is configured to provide a passage for the one or more weights 213 to move from the gravity fall chamber 201 into the buoyancy chamber 203. The receiving portion 207 includes one or more bottom guides 241 and a projecting device 231 disposed at a bottom of the receiving portion 207 for projecting each weight towards a bottom of the buoyancy chamber 203. In FIG. 3C, it is shown that the receiving portion 207 and the buoyancy chamber 203 contain the liquid 223, such as water, etc. or the like. Also, the fall gate 217 is disposed at the bottom of the gravity fall chamber 201, and the buoyancy gate 253 is disposed at the bottom of the buoyancy chamber 203.

As noted earlier, as the weight 213 drops from a height in a predetermined position to the bottom of the gravity fall chamber 201, the fall gate 217 is controlled to open, while keeping the buoyancy gate 253 closed. After the weight 213 passes the fall gate 217, the fall gate 217 is controlled to close the gravity fall chamber 201. As the weight 213 continues to fall and reaches the bottom of the receiving portion 207, the weight 213 makes contact with the projecting device 231 (e.g., a spring like device, etc.), which projects the weight 213 towards the bottom of the buoyancy chamber 203. It is noted that the one or more bottom guides 241 are disposed inside the receiving portion 207 such that the weight 213 is guided towards the projecting device 231 as it moves from the gravity fall chamber 201 to the bottom portion of the receiving portion 207. While the fall gate 217 remains closed, the buoyancy gate 253 is operated to open and the weight 213 moves upward into the buoyancy chamber 203. After the weight 213 passes the buoyancy gate 253, the buoyancy gate 253 is controlled to close the buoyancy chamber 203. The opening and closing operations of both the fall gate 217 and the buoyancy gate 253 are controlled by the controller unit, for example, a micro-controller or computer with certain control logic or the like.

In other words, the fall gate 217 of the gravity fall chamber 201 is controlled by the controller unit to open or close the fall gate 217 in such a way that the weight 213 falls and moves from the bottom of the gravity fall chamber 201 into the receiving portion 207 before rising due to buoyancy in the buoyancy chamber 203. In one embodiment, the controller unit uses one or more sensors (not shown) located within the gravity fall chamber 201 and/or buoyancy chamber 203 to sense one or more positions of the weight 213 and send appropriate control signals to the fall gate 217 and buoyancy gate 253 for coordinated opening and closing operations. That is, based on sensing signals received from the one or more sensors, the controller unit sends a control signal to open the fall gate 217 while keeping the buoyancy gate 253 closed, and sends another control signal to open the buoyancy gate 253 while keeping the fall gate 217 closed, as the weight 213 moves from the receiving portion 207 into the buoyancy chamber 203. Further, the fall gate 217 is controlled to close after the weight 213 passes the position of the fall gate 217 into the receiving portion 207. The buoyancy gate 253 is configured to open such that the weight 213 moves from the receiving portion 207 into the buoyancy chamber 203 for a next round of a fall from the height in the predetermined position.

In the example, the buoyancy gate 253 is controlled by the controller unit such that the buoyancy gate 253 opens while the fall gate 217 remains closed, as the weight 213 moves from the receiving portion 207 into the buoyancy chamber 203. After the weight 213 passes the position of the buoyancy gate 253 and moved upward, the controller unit senses one or more positions of the weight 213 inside the buoyancy chamber 203 and sends a control signal to the buoyancy gate 253 to close. The timings of openings and closings operations of the fall gate 217 and buoyancy gate 253 are controlled and/or coordinated by the controller unit. Alternatively, the timings of the openings and closings of the fall gate 217 and buoyancy gate 253 can be controlled by predetermined timing information using conventional programming and techniques. For example, the fall gate 217 and buoyancy gate 253 can be opened or closed at a predetermined duration after the weight 213 drops from the predetermined drop position using other conventional technologies, such as a timer, etc. or the like.

Further, in the example shown in FIG. 3C, the fall gate 217 is operated by a hydraulic drive system 227 under control by the controller unit of the control box 11. The fall gate 217 is operated (i.e., opened or closed) by a hydraulic drive system 227 that uses pressurized hydraulic fluid to drive the fall gate 217 to open or close the bottom portion of the gravity fall chamber 201. The hydraulic drive system 227 is controlled by the controller unit of the control box 11. Similarly, the buoyancy gate 253 is operated by a hydraulic drive system 228 under control by the controller unit of the control box 11. The hydraulic drive system 228 uses pressurized hydraulic fluid to drive the buoyancy gate 253 to open or close the bottom portion of the buoyancy chamber 203. Alternatively, as shown in FIG. 3D, the fall gate 217 and/or buoyancy gate 253 can be operated by other drive systems, such as a motor-screw drive system, etc., which is described in detail below in FIG. 3D.

FIG. 3D shows an exemplary motor-screw drive system 301 that can be used to open or close the buoyancy gate or fall gate. The exemplary motor-screw drive system 301 includes a motor 303, and a screw type rod 305. The motor 303 is coupled to the screw type rod 305 via a belt and pulley 311. For example, the motor-screw drive system 301 is configured to move the buoyancy gate (or fall gate) 253′ in a forward direction F or a backward direction B along an axis of the screw type rod 305, thereby closing (i.e., moving in a forward direction F) or opening (i.e., moving in a backward direction B) the buoyancy gate (or fall gate) 253′. As the buoyancy gate (or fall gate) 253′ moves in a forward direction F by the operation of the motor 303, the buoyancy gate (or fall gate) 253′ engages a receptacle member 202, thereby closing an opening 204 for example in the buoyancy chamber 203 (or the gravity fall chamber 201).

Referring back to FIG. 3C, the receiving portion 207 of the chamber unit 12 is constructed in such a way that as the weight 213 drops towards a bottom of the receiving portion 207 due to the gravity, the weight 213 makes contact with a projecting device 231 (e.g., a recoil spring, etc. or the like) disposed at the bottom of the receiving portion 207. It is noted that although the weight 213 is buoyant, due to the accelerated downward motion of the weight 213 during its fall, the weight 213 will continue to fall downward even after the weight 213 is submerged in the liquid 223 in the receiving portion 207. When the weight 213 makes contact with the projecting device 231 at the bottom of the receiving portion 207, the projecting device 231 projects the weight 213 upward in a direction of the bottom of the buoyancy chamber 203. In one embodiment, the projecting device 231 is a recoil spring or the like located at a bottom portion of the receiving portion 207. Alternatively, any other devices other than the recoil spring can be used, such as other types of projecting mechanisms for the weight 213, such as liquid jets, a projecting rod, etc. or the like.

As noted above, the receiving portion 207 is constructed so as to facilitate unobstructed downward movement of the weight 213 from the gravity fall chamber 201 to the bottom of the receiving portion 207. That is, the receiving portion 207 is shaped like a cone with a sloped bottom portion of the receiving portion 207 such that the weight 213 continues to move downward to make contact with the projecting device 231, which is disposed at a predetermined location of the bottom of the receiving portion 207. Also, the receiving portion 207 includes one or more bottom guides 241 disposed on the bottom surface of the receiving portion 207. The one or more bottom guides 241 provide passage guidance to the weight 213 such that the weight 213 continues to move from the gravity fall chamber 201 towards the projecting device 231. Thus, the one or more bottom guides 241 provide guidance on the downward movement of the weight 213 after the weight 213 is submerged in the liquid 223 in the receiving portion 207, after the fall gate 217 opens and the weight 213 continues to fall due to gravity or acceleration.

In the example shown in FIG. 3C, the buoyancy chamber 203 includes one or more buoyancy guides 245 disposed inside the buoyancy chamber 203. The buoyancy chamber 203 is substantially filled with the liquid 223, such as water, etc., such that the one or more weights 213 can rise to a surface level of the liquid 247 due to buoyancy in the buoyancy chamber 203. The surface level of the liquid 247 in the buoyancy chamber 203 is maintained by a buoyancy chamber liquid level controller 249. The buoyancy chamber liquid level controller 249 can be a valve for providing an additional amount of the liquid 223 in the buoyancy chamber 203 to maintain a predetermined surface level of the liquid 247. The one or more buoyancy guides 245 disposed inside the buoyancy chamber 203 provide a defined passage for the weight 213 to rise within the buoyancy chamber 203.

The buoyancy gate 253 of buoyancy chamber 203 is disposed at or near a bottom of the buoyancy chamber 203. The buoyancy gate 253 is configured to open or close the bottom portion of the buoyancy chamber 203. As the weight 213 rises from the bottom of the receiving portion 207, the buoyancy gate 253 is operated to open so as to provide a rise passage for the weight 213 in the buoyancy chamber 203, while the fall gate 217 remains closed. As noted earlier, in operations of the fall gate 217 and buoyancy gates 253, it is noted that the buoyancy gate 253 is configured to remain closed as the weight 213 moves from the gravity fall chamber 201 into the receiving portion 207 (e.g., when the fall gate 217 is open) and is configured to open as the weight 213 moves from the receiving portion 207 into the buoyancy chamber 203 (e.g., when the fall gate 217 is closed). The opening and closing operations of the fall gate 217 and buoyancy gate 253 are controlled and coordinated by the controller unit such that the predetermined levels of the liquid 223 in both the buoyancy chamber 203 and gravity fall chamber 201 are maintained during the operation of the chamber unit 12.

FIGS. 4A and 4B illustrate exemplary embodiments including one or more chains 219 with one or more support members 221.

FIG. 4A illustrates another perspective view of an exemplary support member 221 coupled to the chains 219. The chains 219 are roller type chains, which are made from various materials. For example, the chains 219 can be made from plain carbon, alloy steel, metal, plastic, etc. Alternatively, instead of the roller type chains, tracks or the like can be used. In FIG. 4A, the support member 221 is shown as having the form of a rectangular shape coupled to the chains 219, and the support member 221 includes a padding 230 attached on a top of the support member 221. In the example, the padding 230 is made of rubber in a rectangular shape, on which the weight 213 falls and sits as the weight 213 is released by the weight stopper 265. Alternatively, the padding 230 can be in the form of various shapes and be made of other materials such as silicon, etc. or the like for durability and elasticity purposes. The exemplary support member 221 is coupled to the chains 219 by an attachment means such as screws, welds, pins, etc. or the like. Also, as noted earlier, the chains 219 comprise two rolling type chains each comprising two or more chain modules 224 linked to each other. In another embodiment, the chains 219 can comprise a single chain comprising two or more chain modules linked to each other. Also, an idle roller can be disposed near the support member 221 inside the chains 219 to maintain a predetermined level of tension in the chains 219.

FIG. 4B is another perspective view illustrating a bottom portion of the exemplary chains 219. In one embodiment, the bottom portion of the exemplary chains 219 includes a pair of chain sprockets or gears 271, a clutch bearing 272, a shaft 273, and a v-pulley 275. A chain sprocket or gear 271 is a profiled wheel with teeth that mesh with the chains 219. The pair of chain gears 271 is coupled to the clutch bearing 272 via the shaft 273. The v-pulley 275 is disposed at one end of the shaft 273 and is configured to engage, via a v-belt 293, a flywheel 291 of the generator unit 13 (as shown in FIG. 5). Also, a spring stopper 276 is disposed near one end of the chains 219 and configured to position the support member 221 coupled to the chains 219 at a predetermined position relative to the height of the fall in the gravity fall chamber 201.

In the example, the v-pulley 275 is a common industrial type v-pulley and the v-belt 293 has a 40 degree angle between its faces, which are widely used in industrial machinery. Alternatively, other types of pulleys and belts can be used instead.

In the example discussed herein, when the weight stopper 265 releases the weight 213 to fall from a height in a predetermined position in the gravity fall chamber 201, the support member 221 of the chain 219 receives the weight 213 and starts to move downward along with the weight 213 which is disposed on the top of the support member 221, as the gravity of the earth pulls downward the weight 213 and support member 221. As the weight 213 (and the support member 221) falls and accelerates, its gravitational potential energy stored at the height is converted into kinetic energy. At the same time, the fall of the weight 213 and support member 221 drives the chains 219 and sets it in motion in a downward direction, which in turn drives the sprocket 271 coupled to the shaft 273 in FIG. 4B. The movement of the chains 219 in turn rotates the v-pulley 275 and moves the v-belt 293 which is shown in FIG. 5. The v-belt 293 then engages the flywheel 292, turning it. The rotational movement of the flywheel 292 powers the generator 295, which then generates electricity as an output. The above process repeats with each weight 213. As a result, the weight 213 is raised to the height by buoyancy and falls from the height and accelerates converting the gravitation potential energy stored in the weight 213 at the height into electricity, using gravity or gravity acceleration and buoyancy.

FIG. 5 shows a perspective view of an exemplary generator unit 13. In the example, the exemplary generator unit 13 includes a v-belt 293, a flywheel 291, a clutch 292, and a generator 295. The flywheel 291 is coupled to the v-belt 293. As the v-belt 293 moves, the flywheel 291 rotates and engages the generator 295 via the clutch 292. As noted earlier, kinetic energy produced by the movement of the chains 219 is transferred to the flywheel 291 by the v-belt 293 and stored as rotational energy in the flywheel 291. The flywheel 291 is a conventional rotating device that is used to store rotational energy, which has a significant moment of inertia and provides continuous energy. As the v-belt 293 rotates the flywheel 291, the clutch 292 engages the generator 295 which produces electricity (i.e., the kinetic energy is converted into electric energy). Alternatively, because there may be a need to build up the rotational energy stored in the flywheel 291, the clutch 292 may not immediately engage the generator 295; that is, the flywheel 291 is allowed rotate freely for some time to store a certain amount of rotational energy before engaging the generator 295 for producing electricity (i.e., the clutch 292 is not coupled to the generator 295). In one embodiment, the clutch 292 is an electrical clutch which automatically engages the generator 295 as the flywheel 291 rotates at a certain speed. In another embodiment, the clutch 292 can be a manual clutch which can be engaged by a user or operator.

It is appreciated that electricity produced using the disclosed techniques herein is proportional in part to the height of a fall of the weight 213. Further, it is noted that initially, a small amount of external power may be needed for operational purposes, e.g., operations of the controller unit, fall gate 217 and buoyancy gate 253, etc. However, after an exemplary apparatus utilizing the disclosed techniques herein is put into operation, a small amount of electricity that is generated can be used to supply electric power needed for continued operations of the devices, thereby making the exemplary apparatus a self-sufficient power apparatus. Alternatively, the small amount of the initial electricity can be provided to the exemplary apparatus by an external power source such as a battery (i.e., 12V automotive battery) or other manually operated power generating devices.

In another embodiment, a configuration of multiple exemplary apparatuses can be set up in parallel to produce a large amount of electricity for use by an industrial facility. For example, two or more exemplary apparatuses can be built and installed in parallel and electricity produced by each apparatus can be combined.

FIG. 6 illustrates a cross-cut view of an exemplary weight 213. The exemplary weight 213 is manufactured such that it weighs less than a weight of a volume of the liquid 223 displaced by the exemplary weight 213 when the exemplary weight 213 is submerged within the liquid 223, that is, the exemplary weight 213 is made buoyant. In one embodiment, the exemplary weight 213 comprises an outer shell portion 401 and a hollow space 403 defined by the outer shell portion 401. In another embodiment, the weight 213 is constructed from a material, of which specific gravity is less than 1.2. The specific gravity is defined herein as the ratio of the density of a substance to the density of a reference substance such as water. Further, its outer shall 401 is made of engineering plastic such as a MC nylon type material. Alternatively, other than MC nylon type materials, such as plastics, engineering fibers, etc. or the like can be used for manufacturing the weight 213. Also, the weight 213 can be made in any size or shape as long as the force of the weight 213 is maximized as it falls within the gravity fall chamber 201, and splashes or noises are minimized when it makes contact with the liquid 223. In the example, the weight 213 is constructed such that a volume of the hollow space defined by the outer shell portion 401 is about ⅖ of the total volume of the weight 213.

FIGS. 7A and 7B provide functional block diagram illustrations of a controller unit of the control box 11. FIG. 7A illustrates a computer platform, as may typically be used to implement a controller unit or a server. In one embodiment, the controller unit can serve as a server for other controller units for operations of the fall gate, buoyancy gate, etc. in a client-server environment. FIG. 7B depicts another computer platform with user interface elements, as may be used to implement a personal computer or other type of work station or terminal device, although the controller unit of FIG. 7B may also act as a server if appropriately programmed in a client-server environment. It is believed that the structure, programming and general operation of such computer equipment are well known and as a result the drawings should be self-explanatory.

A controller unit, for example, includes a data communication interface for packet data communication. The controller unit also includes a central processing unit (CPU), in the form of one or more processors, for executing program instructions. The controller unit typically includes an internal communication bus, program storage and data storage for various data files to be processed and/or communicated by the controller unit, although the controller unit can receive programming and data via network communications. The network communications can be implemented either wirelessly over the air or wireline connections. The hardware elements, operating systems and programming languages of such controller units are conventional in nature, and are well known. Of course, functions for the controller unit may be implemented in a distributed fashion on a number of similar platforms, to distribute the processing load. The functions for the controller unit or programming instructions include instructions to control various components of the exemplary apparatus 10, such as the weight stopper 265, fall gate 217, buoyancy gate 253, fall chamber liquid level controller, buoyancy chamber liquid level controller, etc.

A computer type user terminal device, such as a PC or tablet computer, similarly includes a data communication interface CPU, main memory and one or more mass storage devices for storing user data and the various executable programs. The controller unit may include similar elements, but will typically use smaller components that also require less power, to facilitate implementation in a various industrial form factor. The various types of controller units will also include various user input and output elements. A computer, for example, may include a keyboard and a cursor control/selection device such as a mouse, trackball, joystick or touchpad, and a display for visual outputs. A microphone and speaker enable audio input and output. Some exemplary controller units may utilize touch sensitive display screens, instead of separate keyboard and cursor control elements. It is presumed that the hardware elements, operating systems and programming languages of such controller units also are conventional in nature and are well known.

Hence, aspects of the methods of sensing locations and/or positions of the weights in the gravity fall chamber 201, buoyancy chamber 203, and receiving portion of the exemplary apparatus 10 and controlling the weight stopper 265, fall gate 217 and buoyancy gate 253, etc. as outlined above, may be embodied in programming. Program aspects of the technology may be thought of as “products” or “articles of manufacture” typically in the form of executable code and/or associated data that is carried on or embodied in a type of machine readable medium. Storage type media include any or all of the tangible memory of the computers, processors or the like, or associated modules thereof, such as various semiconductor memories, tape drives, disk drives and the like, which may provide non-transitory storage at any time for the software programming. All or portions of the software may at times be communicated through the Internet or various other telecommunication networks. Such communications, for example, may enable loading of the software from one computer or processor into another, for example, from a management server into the computer platform. Thus, another type of media that may bear the software elements includes optical, electrical and electromagnetic waves, such as used across physical interfaces between local devices, through wired and optical landline networks and over various air-links. The physical elements that carry such waves, such as wired or wireless links, optical links or the like, also may be considered as media bearing the software. As used herein, unless restricted to non-transitory, tangible storage media, terms such as computer or machine “readable medium” refer to any medium that participates in providing instructions to a processor for execution.

Hence, a machine readable medium may take many forms, including but not limited to, a tangible storage medium, a carrier wave medium or physical transmission medium. Non-volatile storage media include, for example, optical or magnetic disks, such as any of the storage devices in any computer(s) or the like, such as may be used to implement, for example, the techniques for controlling the weight stopper 265, fall gate 217, buoyancy gate 253, etc. shown in the drawings. Volatile storage media include dynamic memory, such as main memory of such a computer platform. Tangible transmission media include coaxial cables, copper wire and fiber optics, including the wires that comprise a bus within a computer system. Carrier-wave transmission media can take the form of electric or electromagnetic signals, or acoustic or light waves such as those generated during radio frequency (RF) and infrared (IR) data communications. Common forms of computer-readable media therefore include for example: a floppy disk, a flexible disk, hard disk, magnetic tape, any other magnetic medium, a CD-ROM, DVD or DVD-ROM, any other optical medium, punch cards paper tape, any other physical storage medium with patterns of holes, a RAM, a PROM and EPROM, a FLASH-EPROM, any other memory chip or cartridge, a carrier wave transporting data or instructions, cables or links transporting such a carrier wave, or any other medium from which a computer can read programming code and/or data. Many of these forms of computer readable media may be involved in carrying one or more sequences of one or more instructions to a processor for execution.

It is understood that various modifications may be made therein and that the subject matter disclosed herein may be implemented in various forms and examples, and that the teachings may be applied in numerous applications, only some of which have been described herein. It is intended by the following claims to claim any and all applications, modifications and variations that fall within the true scope of the present teachings.

Unless otherwise stated, all measurements, values, ratings, positions, magnitudes, sizes, and other specifications that are set forth in this specification, including in the claims that follow, are approximate, not exact. They are intended to have a reasonable range that is consistent with the functions to which they relate and with what is customary in the art to which they pertain.

The scope of protection is limited solely by the claims that now follow. That scope is intended and should be interpreted to be as broad as is consistent with the ordinary meaning of the language that is used in the claims when interpreted in light of this specification and the prosecution history that follows and to encompass all structural and functional equivalents. Notwithstanding, none of the claims are intended to embrace subject matter that fails to satisfy the requirement of Sections 101, 102, or 103 of the Patent Act, nor should they be interpreted in such a way. Any unintended embracement of such subject matter is hereby disclaimed.

Except as stated immediately above, nothing that has been stated or illustrated is intended or should be interpreted to cause a dedication of any component, step, feature, object, benefit, advantage, or equivalent to the public, regardless of whether it is or is not recited in the claims.

It will be understood that the terms and expressions used herein have the ordinary meaning as is accorded to such terms and expressions with respect to their corresponding respective areas of inquiry and study except where specific meanings have otherwise been set forth herein. Relational terms such as first and second and the like may be used solely to distinguish one entity or action from another without necessarily requiring or implying any actual such relationship or order between such entities or actions. The terms “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus. An element proceeded by “a” or “an” does not, without further constraints, preclude the existence of additional identical elements in the process, method, article, or apparatus that comprises the element.

As utilized herein, the terms “approximately,” “about,” “substantially,” and similar terms are intended to have a broad meaning in harmony with the common and accepted usage by those of ordinary skill in the art to which the subject matter of this disclosure pertains. It should be noted that these terms should be interpreted as indicating that insubstantial or inconsequential modifications or alterations of the subject matter described and claimed are considered to be within the scope of the invention, as recited in the appended claims.

For the purpose of this disclosure, the term “coupled” means the joining of two members directly or indirectly to one another. Such joining may be stationary in nature or moveable in nature. Such joining may be achieved with the two members and the two members and any additional intermediate members being integrally formed as a single unitary body with one another or with the two members or the two members and any additional intermediate members being attached to one another. Such joining may be permanent in nature or may be removable or releasable in nature. The term “coupling” includes creating a connection between two components.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various embodiments for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separately claimed subject matter.

What is claimed is:

1. An apparatus for generating electricity using gravity and buoyancy, the apparatus comprising:
a weight;
a gravity fall chamber including a fall gate disposed at a bottom of the gravity fall chamber;
means for receiving the weight as the weight falls from a height near a top of the gravity fall chamber, wherein the means for receiving the weight is configured to receive the weight and to move downward together with the weight, as the weight falls due to gravity of the earth exerted upon the weight;
a buoyancy chamber including a liquid filled inside the buoyancy chamber and a buoyancy gate disposed at a bottom of the buoyancy chamber;
a receiving portion configured to connect the gravity fall chamber and the buoyancy chamber so as to create a passage for the weight to move from the gravity fall chamber into the buoyancy chamber,
wherein:
the weight is configured to weigh less than a weight of a volume of the liquid displaced by the weight when the weight is submerged within the liquid;
the fall gate of the gravity fall chamber is configured to open such that the weight falls from the gravity fall chamber into the receiving portion, while the buoyancy gate of the buoyancy chamber is closed, and
the buoyancy gate of the buoyancy chamber is configured to open such that the weight moves from the receiving portion into the buoyancy chamber for rise due to buoyancy inside the buoyancy chamber, while the fall gate of the gravity fall chamber is closed.

2. The apparatus of claim 1, wherein the weight comprises an outer shell and a hollow space defined by the outer shell.

3. The apparatus of claim 2, wherein the outer shell is made of an engineering plastic material including a MC nylon type material.

4. The apparatus of claim 1, wherein the means for receiving the weight comprises:
a chain; and
a plurality of support members coupled to the chain.

5. The apparatus of claim 1, wherein the gravity fall chamber includes one or more fall guides for guiding downward movement of the weight as the weight falls due to gravity in the gravity fall chamber.

6. The apparatus of claim 1, wherein the buoyancy chamber includes one or more rise guides for guiding upward movement of the weight as the weight rises due to buoyancy inside the buoyancy chamber.

7. The apparatus of claim 1, wherein the receiving portion comprises:
one or more bottom guides disposed inside the receiving portion, and
a projecting device disposed at the bottom of the receiving portion, wherein the projecting device is configured to project the weight upward towards the buoyancy chamber as the weight make contact with the projecting device.

8. The apparatus of claim 1, wherein the gravity fall chamber further includes a fall chamber liquid level controller for draining the liquid to maintain a predetermined level of the liquid inside the gravity fall chamber, and wherein the fall chamber liquid level controller is disposed near the bottom of the gravity fall chamber.

9. The apparatus of claim 1, wherein the fall gate is operatively coupled to the gravity fall chamber by either a hydraulic drive system or a motor-screw drive system.

10. The apparatus of claim 1, wherein the buoyancy gate is operatively coupled to the buoyancy chamber by either a hydraulic drive system or a motor-screw drive system.

11. The apparatus of claim 1, further comprising a weight stopper disposed at a top portion of the apparatus, wherein the weight stopper is configured to hold the weight in a predetermined position as the weight moves from a top portion of the buoyancy chamber for a fall into the gravity fall chamber.

12. The apparatus of claim 4, wherein downward movement of the chain causes rotational movement of one or more chain sprockets, which in turn causes movement of a V-pulley coupled to the one or more chain sprockets.

13. The apparatus of claim 4, further comprising a stopper for positioning the one or more support members attached to the chain at a predetermined position.

14. A method for generating electricity using an apparatus comprising one or more weights, a gravity fall chamber including a fall gate, a buoyancy chamber including a buoyancy gate and a liquid inside the buoyancy chamber, and a receiving portion connecting the gravity fall chamber and the buoyancy chamber so as to allow the one or more weights to move from the gravity fall chamber into the buoyancy chamber, wherein each of the one or more weights is configured to weigh less than a weight of a volume of the liquid disposed by the weight when the weight is submerged within the liquid, the gravity fall chamber further includes a chain and a support member coupled to the chain, the method comprising steps of:
allowing the one or more weights to fall from a height into the gravity fall chamber;
receiving the one or more weights via the support member of the chain;
allowing a combined mass of the one or more weights and the support member to fall, thereby making downward movement of the chain, as the combined mass falls toward a bottom of the gravity fall chamber;
operating the fall gate to open such that the one or more weights move from the gravity fall chamber into the receiving portion while operating the buoyancy gate to remain closed;
receiving the one or more weights into the receiving portion;
projecting the received one or more weights to move into the buoyancy chamber; and
while operating the fall gate to remain closed, operating the buoyancy gate to open such that the one or more weights move from the receiving portion into the buoyancy chamber and subsequently rise in the liquid to a surface level of the liquid in the buoyancy chamber.

15. The method of claim 14, wherein the step of allowing the one or more weights to fall from the height comprises holding the one or more weights via a weight stopper in a predetermined position at the height before allowing the one or more weights to fall into the gravity fall chamber.

16. The method of claim 14, wherein the step of receiving the one or more weights into the receiving portion comprises receiving the one or more weights into a bottom of the receiving portion, and wherein the one or more weights make contact with a projecting device disposed at the bottom of the receiving portion.

17. The method of claim 16, wherein the step of projecting the one or more weights comprises projecting the one or more weights using the projecting device disposed at the bottom of the receiving portion when the one or more weights make contact with the projecting device.

18. An apparatus for generating electricity using gravity and buoyancy, the apparatus comprising:
a gravity fall chamber including a fall gate disposed at or near a bottom of the gravity fall chamber;
a buoyancy chamber including a liquid and a buoyancy gate disposed at or near a bottom of the buoyancy chamber, wherein the buoyancy chamber is disposed substantially vertically adjacent the gravity fall chamber;
a chain including a plurality of support members, wherein the chain is disposed inside the gravity fall chamber substantially along a longitudinal side of the gravity fall chamber, and the plurality of support members is configured to receive one or more weights as the one or more weights fall from a height in a predetermined position near a top of the gravity fall chamber and move the chain downward, as the one or more weights drop and accelerate due to gravity; and
a receiving portion configured to connect the gravity fall chamber and the buoyancy chamber so as to create a passage for the one or more weights to move from the gravity fall chamber into the buoyancy chamber,
wherein:
each of the one or more weights is configured to weigh less than a weight of a volume of the liquid displaced by the weight when the weight is submerged within the liquid,
the fall gate of the gravity fall chamber is configured to open so as for each weight to move from the gravity fall chamber into the receiving portion, while the buoyancy gate of the buoyancy chamber is closed, and
the buoyancy gate of the buoyancy chamber is configured to open so as for the weight to move from the receiving portion into the buoyancy chamber for rise due to buoyancy to a surface level of the liquid inside the buoyancy chamber.

19. The apparatus of claim 18, wherein the gravity fall chamber includes one or more fall guides for guiding downward movement of the one or more weights as the one or more weights fall due to gravity in the gravity fall chamber.

20. The apparatus of claim 18, wherein the buoyancy chamber includes one or more rise guides for guiding upward movement of the one or more weights as the one or more weights rise due to buoyancy inside the buoyancy chamber.
